(19) United States
(12) Patent Application Publication
(10) Pub. No.: US 2026/0159270 A1
(43) Pub. Date: Jun. 11, 2026

(54) CONTAINER FOR PRODUCTS

(71) Applicant: Graphic Packaging International, LLC, Atlanta, GA (US)

(72) Inventors: Jamie Skipper, Leicester (GB); Marc Kavanagh, Kent (GB)

(21) Appl. No.: 19/399,727

(22) Filed: Nov. 25, 2025

Related U.S. Application Data
(60) Provisional application No. 63/728,774, filed on Dec. 6, 2024.

(51) Int. Cl. B65D 5/48; B31B 50/26; B65D 5/20; B65D 5/32

(52) U.S. Cl. CPC B65D 5/48002; B31B 50/26; B65D 5/2033; B65D 5/321

(57) ABSTRACT

A container for holding one or more products. The container can comprise a base comprising a bottom panel and a plurality of panels foldably connected to the bottom panel and a crown comprising a flange panel extending at least partially around an opening and a plurality of flaps foldably connected to the flange panel. A bottom wall comprises the bottom panel of the base and a sidewall comprises the plurality of panels of the base and the plurality of flaps of the crown. The sidewall and the bottom wall at least partially define an interior of the container. A flange comprises the flange panel and extends outwardly from the sidewall. A storage feature is at least partially defined in the bottom wall and comprises a storage compartment separated from the interior of the container.

### CROSS-REFERENCE TO RELATED APPLICATION

The present application claims the benefit of U.S. Provisional Ser. No. 63/728,774, filed Dec. 6, 2024.

### INCORPORATION BY REFERENCE

The disclosure of U.S. Provisional Ser. No. 63/728,774 , filed Dec. 6, 2024, is hereby incorporated by reference for all purposes as if presented herein in its entirety. The disclosures of U.S. patent application Ser. No. 18/912,820, filed Oct. 11, 2024, U.S. patent application Ser. No. 18/805,998, filed Aug. 15, 2024, U.S. Provisional Ser. No. 63/679,809, filed Aug. 6, 2024, U.S. Provisional Ser. No. 63/543,560 , filed Oct. 11, 2023, U.S. Provisional Ser. No. 63/541,446 , filed Sep. 29, 2023, U.S. Provisional Ser. No. 63/533,393 , filed Aug. 18, 2023, U.S. patent application Ser. No. 16/037,425, filed Jul. 17, 2018, U.S. patent application Ser. No. 15/654,814, filed Jul. 20, 2017, and U.S. patent application Ser. No. 12/992,131, filed Feb. 11, 2011, are hereby incorporated by reference for all purposes as if presented herein in their entirety.

### BACKGROUND OF THE DISCLOSURE

The present disclosure relates to blanks, containers, trays, constructs, and various features and methods for forming a container from a blank. More specifically, the disclosure is generally directed to a container having an additional compartment.

### SUMMARY OF THE DISCLOSURE

In general, one aspect of the disclosure is generally directed to a container for holding one or more products. The container can comprise a base comprising a bottom panel and a plurality of panels foldably connected to the bottom panel and a crown comprising a flange panel extending at least partially around an opening and a plurality of flaps foldably connected to the flange panel. A bottom wall comprises the bottom panel of the base and a sidewall comprises the plurality of panels of the base and the plurality of flaps of the crown. The sidewall and the bottom wall at least partially define an interior of the container. A flange comprises the flange panel and extends outwardly from the sidewall. A storage feature is at least partially defined in the bottom wall and comprises a storage compartment separated from the interior of the container.

In another aspect, the disclosure is generally directed to a combination of blanks for forming a container for holding one or more products. The combination of blanks comprises a base blank for forming a base of the container. The base blank comprises a bottom panel and a plurality of panels foldably connected to the bottom panel. The bottom panel is for forming a bottom wall of the base of the container. A crown blank comprises a flange panel extending at least partially around an opening and a plurality of flaps foldably connected to the flange panel. The flange panel is for at least partially forming a flange of the container. The plurality of flaps of the crown blank and the plurality of panels of the base blank are for forming a sidewall extending at least partially around an interior of the container formed from the combination of blanks. The sidewall and the bottom wall are for at least partially defining the interior of the container formed from the combination of blanks. The flange of the container extends outwardly from the sidewall. A storage structure is for forming a storage feature in the container formed from the combination of blanks. The storage structure is at least partially defined in the bottom panel. The storage feature comprises a storage compartment separated from the interior of the container formed from the combination of blanks.

In another aspect, the disclosure is generally directed to a method of forming a container for holding one or more products. The method comprises obtaining a base blank, the base blank comprising a bottom panel, a plurality of panels foldably connected to the bottom panel, and a storage structure at least partially defined in the bottom panel. The method comprises obtaining a crown blank comprising a flange panel extending at least partially around an opening and a plurality of flaps foldably connected to the flange panel. The method comprises forming a base from the base blank, forming a crown from the crown blank, and at least partially forming a flange from the flange panel. The method comprises forming a bottom wall of the container from the bottom panel and forming a sidewall of the container from the plurality of panels of the base blank and the plurality of flaps of the crown blank such that the sidewall extends at least partially around an interior of the container. The sidewall and the bottom wall at least partially define the interior of the container and the flange of the container extends outwardly from the sidewall. The method includes forming a storage feature from the storage structure, the storage feature comprising a storage compartment separated from the interior of the container.

Those skilled in the art will appreciate the above stated advantages and other advantages and benefits of various additional embodiments reading the following detailed description of the embodiments with reference to the below-listed drawing figures.

### BRIEF DESCRIPTION OF THE DRAWINGS

According to common practice, the various features of the drawings discussed below are not necessarily drawn to scale. Dimensions of various features and elements in the drawings may be expanded or reduced to more clearly illustrate the embodiments of the disclosure.

FIG. 1 is a plan view of a base blank for forming a base of a container according to exemplary embodiments of the disclosure.

FIG. 2 is a plan view of a crown blank for forming a crown of the container according to exemplary embodiments of the disclosure.

FIG. 3 is a perspective view of the container formed from the blanks of FIGS. 1 and 2 according to exemplary embodiments of the disclosure.

FIG. 3A is an exploded perspective view of the container of FIG. 3.

FIG. 4 is a perspective bottom view of the container of FIG. 3.

FIGS. 5A and 5B are perspective bottom views of the container of FIGS. 3 and 4 showing a utensil in a storage compartment according to the exemplary embodiments of the disclosure.

FIG. 5C is a perspective bottom view of the container and accessory of FIGS. 5A and 5B with a covering film applied over the storage compartment according to the exemplary embodiments of the disclosure.

Corresponding parts are designated by corresponding reference numbers throughout the drawings.

### DETAILED DESCRIPTION OF THE EXEMPLARY EMBODIMENTS

The present disclosure relates generally to various aspects of containers, constructs, trays, materials, packages, elements, and articles, and methods of making such containers, constructs, trays, materials, packages, elements, and articles. Although several different aspects, implementations, and embodiments are disclosed, numerous interrelationships between, combinations thereof, and modifications of the various aspects, implementations, and embodiments are contemplated hereby. In one illustrated embodiment, the present disclosure relates to forming a container or tray for holding food items or various other articles. However, in other embodiments, the container or tray can be used to form other non-food containing articles or may be used for heating or cooking. In this specification, the terms “inner,” “interior,” “outer,” “exterior,” “lower,” “bottom,” “upper,” and “top” indicate orientations determined in relation to fully erected and upright packages. As described herein, constructs can be formed from blanks with multiple panels, portions, tabs, flaps, fold lines and/or other lines of weakening, and/or other aspects, which may be designated herein in terms relative to one another, e.g., “first”, “second”, “third”, etc., in sequential or nonsequential reference, without departing from the disclosure.

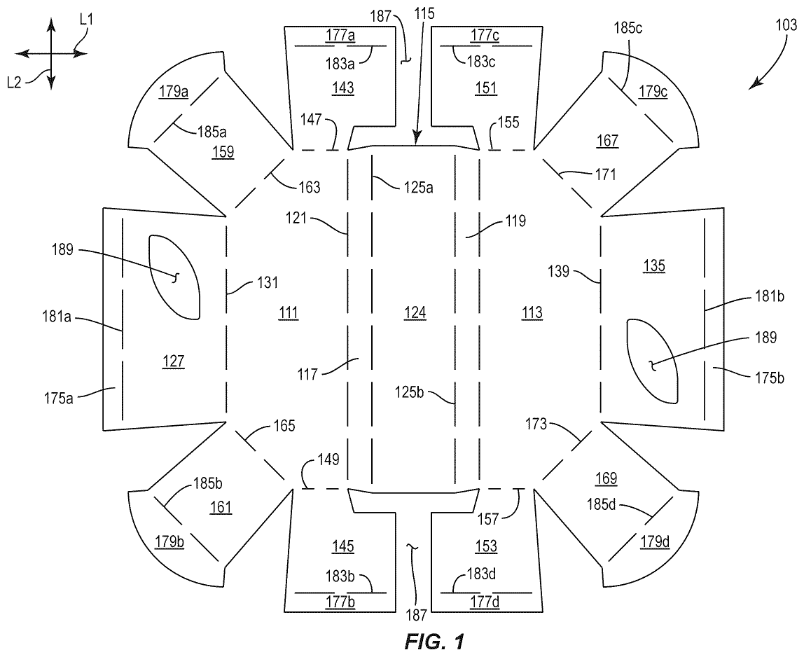

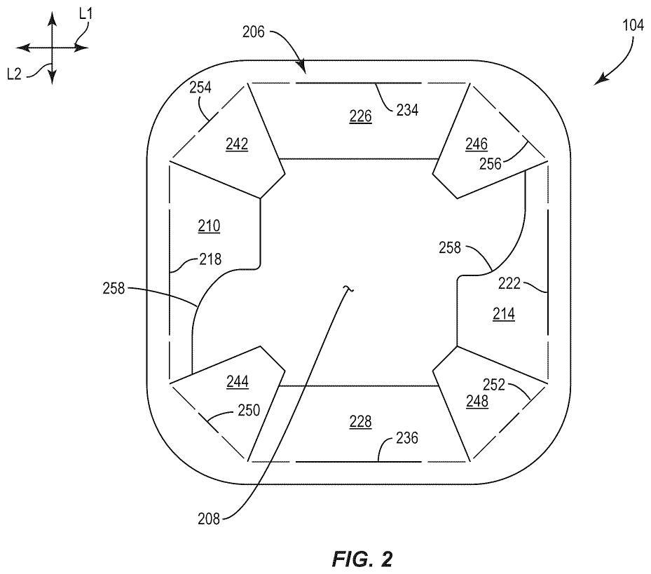

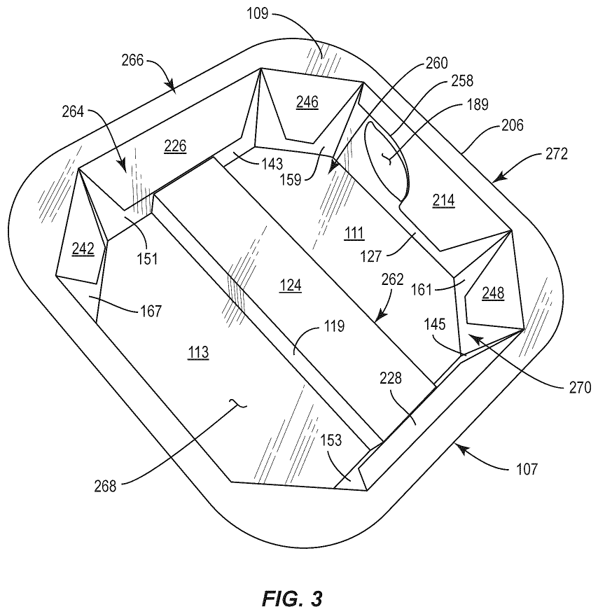

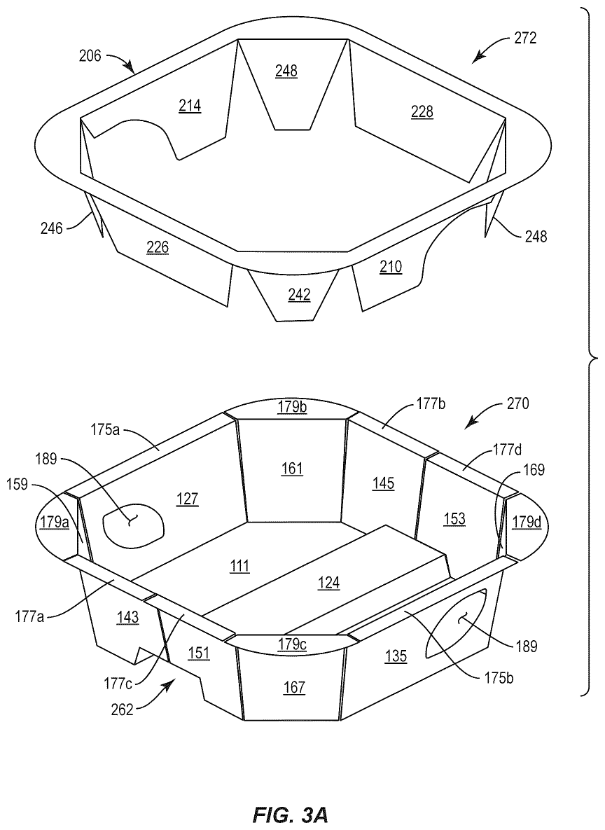

FIGS. 1 and 2 illustrate a first or bottom or base blank 103 and a second or top or crown blank 104, respectively, that are used to at least partially form a container 105 (FIGS. 3-5B). In exemplary embodiments, the blanks 103, 104 comprise paperboard (e.g., solid bleached sulphate folding boxboard) or other suitable material that can be recyclable and can at least partially form a base layer 107 of the container 105. In some embodiments, a liner 109 (FIG. 3) can be applied over at least a portion of the base layer 107 and can comprise a plastic layer such as polyethylene, PET material, or any other thermoplastic material, or a bioplastic, such as vegetable oil or starch-based plastics. The container 105 can be suitable for holding and/or displaying one or more articles (e.g., food/beverage products) for sale, transportation, storage, etc., for serving articles (e.g., food/beverage products) and/or for heating a food/beverage product in an oven such as a convection or conventional heating oven or microwave oven. In the illustrated embodiments, the liner 109 can be adhered to the base layer 107 (e.g., along at least a portion of the base formed from the base blank 103 and at least a portion of the crown formed from the crown blank 104) and can be in contact with the food/beverage product held in the container 105. After use of the container 105, the base layer 107 and the liner 109 can be separated to allow both the base layer 107 and the liner to be placed in separate waste streams (e.g., for recycling, composting, incineration, land fill, etc.). In embodiments, the liner 109 could be omitted.

As shown in FIG. 1, the base blank 103 has a longitudinal direction L1 and a lateral direction L2. In the illustrated embodiment, the base blank 103 has a first bottom panel 111 and a second bottom panel 113 connected by a storage structure 115. As shown in FIG. 1, the storage structure 115 can include a first storage panel 117 and a second storage panel 119, wherein the first storage panel 117 is foldably connected to the first bottom panel 111 along a lateral fold line 121 and the second storage panel 119 is foldably connected to the second bottom panel 113 along a lateral fold line 123. The first storage panel 117 and the storage panel 119 can be foldably connected to a central storage panel 124 along respective lateral folds line 125a, 125b. The base blank 103 further can include a first end panel 127 foldably connected to the first bottom panel 111 along a lateral fold line 131 and a second end panel 135 foldably connected to the second bottom panel along a lateral fold line 139. As shown in FIG. 1, a first side panel 143 and an opposing second side panel 145 can be foldably connected to the first bottom panel 111 along respective longitudinal fold lines 147, 149, and a third side panel 151 and an opposing fourth side panel 153 can be foldably connected to the second bottom panel 113 along respective longitudinal fold lines 155, 157.

In the illustrated embodiments, the base blank 103 can include corner panels 159, 161 respectively foldably connected to the first bottom panel 111 along respective oblique fold lines 163, 165 and corner panels 167, 169 respectively foldably connected to the second bottom panel 113 along respective oblique fold lines 171, 173. As shown in FIG. 1, the corner panel 159 is disposed between the first end panel 127 and the first side panel 143, the corner panel 161 is disposed between the first end panel 127 and the second side panel 145, the corner panel 167 is disposed between the second end panel 135 and the third side panel 151, and the corner panel 169 is disposed between the second end panel 135 and the fourth side panel 153.

In the illustrated embodiments, each of the end panels 127, 135, side panels 143, 145, 151, 153, and corner panels 159, 161, 167, 169 can be foldably connected to a respective flange portion 175a, 175b, 177a, 177b, 177c, 177d, 179a, 179b, 179c, 179d along respective fold lines 181a, 181b, 183a, 183b, 183c, 183d, 185a, 185b, 185c, 185d (e.g., the flange portions can be portions of the respective end panels, side panels. and corner panels at least partially defined by the respective fold lines). As shown in FIG. 1, the first bottom panel 111, the first side panel 143, and the second side panel 145 can be spaced apart from the second bottom panel 113, the third side panel 151, and the fourth side panel 153 in the blank 103 so that cutouts 187 are at least partially defined between the first and third side panels 143, 151 and between the second and fourth side panels 145, 153. In embodiments, one of the cutouts can be defined at least partially along edges of the side panels 143, 151 and edges of the panels 117, 119, 124 of the storage structure 115, and the other cutout 187 can be defined at least partially along edges of the side panels 145, 153 and edges of the panels 117, 119, 124 of the storage structure 115. In the illustrated embodiments, the cutouts 187 can extend between portions of each of the side panels 143, 151, 145, 153 and the storage structure 115 in the base blank 103.

As shown in FIG. 1, the base blank 103 can include an aperture 189 at least partially defined in each of the end panels 127, 135 for at least partially forming windows in the sidewall of the container 105. The base blank 103 could be otherwise shaped, arranged, and/or configured without departing from the disclosure. In addition, any of the bottom panels 111, 113, the end panels 127, 135, the side panels 143, 145, 151, 153, the corner panels 159, 161, 167, 169, and/or the flange portions 175a, 175b, 177a, 177b, 177c, 177d, 179a, 179b, 179c, 179d could be omitted or could be otherwise shaped, arranged, positioned, and/or configured without departing from the disclosure. For example, the base blank 103 could have any suitable number of panels and any suitable shape for the perimeter around the bottom panels 111, 113.

As shown in FIG. 2, the crown blank 104 has a longitudinal direction L1 and a lateral direction L2 and includes a flange panel 206 extending around a perimeter of the crown blank 104 (e.g., continuously around the crown blank 104 for forming a smooth, continuous upper surface of the flange of the container 105 for attaching the liner and/or a lid film). In the illustrated embodiments, the crown blank 104 can include a central opening 208, and a first end flap 210, a second end flap 214, a first side flap 226, a second side flap 228, and corner flaps 242, 244, 246, 248 can be foldably connected to the flange panel 206 along the central opening 208. As shown in FIG. 2, the first end flap 210 and the second end flap 214 can be foldably connected to the flange panel 206 along respective lateral fold lines 218, 222, the first side flap 226 and the second side flap 228 can be foldably connected to the flange panel 206 along respective longitudinal fold lines 234, 236, and the corner flaps 242, 244, 246, 248 can be foldably connected to the flange panel 206 along respective oblique fold lines 250, 252, 254, 256.

In the illustrated embodiments, the flaps of the crown blank 104 can abut one another and can be separable from one another along respective cut lines (or tear lines or other lines of weakening). In embodiments, the end flaps 210, 214 can include respective cutouts 258 for accommodating the apertures 189 in the respective end panels 127, 135 of the base blank 103 (e.g., so that the end flaps 210, 214 do not overlap the apertures 189 in the sidewall of the container 105. The crown blank 104 could be otherwise shaped, arranged, and/or configured without departing from the disclosure. In addition, any of the flange panel 206, the end flaps 210, 214, the side flaps 226, 228, and/or the corner flaps 242, 244, 246, 248, could be omitted or could be otherwise shaped, arranged, positioned, and/or configured without departing from the disclosure. For example, the crown blank 104 could have any suitable number of panels and any suitable shape for the perimeter around the central opening 208.

When the container 105 is formed from the base blank 103 and the crown blank 104 (e.g., manually or by a forming tool), the base blank 103 can be formed into a base 270 and the crown blank 104 can be formed into the crown 272 (FIGS. 3 and 3A). For example, the storage structure 115 can be formed by folding along the lateral fold lines 121, 123, 125a, 125b so that the central panel 124 is moved upwardly with respect to the bottom panels 111, 113 and the storage panels 117, 119 extend at least upwardly from the respective bottom panels 111, 113 to the central panel 124, while moving the bottom panels 111, 113 closer together. As the bottom panels 111, 113 are moved together, the lateral edges of the side panels 143, 151 are brought together (e.g., so that the lateral edges abut one another and/or are proximate one another) and the lateral edges of the side panels 145, 153 are brought together (e.g., so that the lateral edges abut one another and/or are proximate one another). In embodiments, the bottom panels 111, 113, the central panel 124, and the storage panels 117, 119 can cooperate to at least partially form a bottom wall 260 (FIGS. 3-5B) of the container.

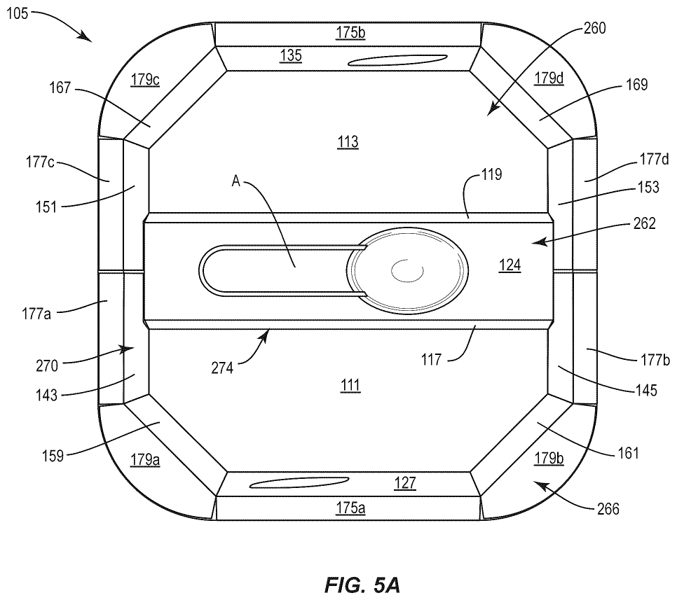

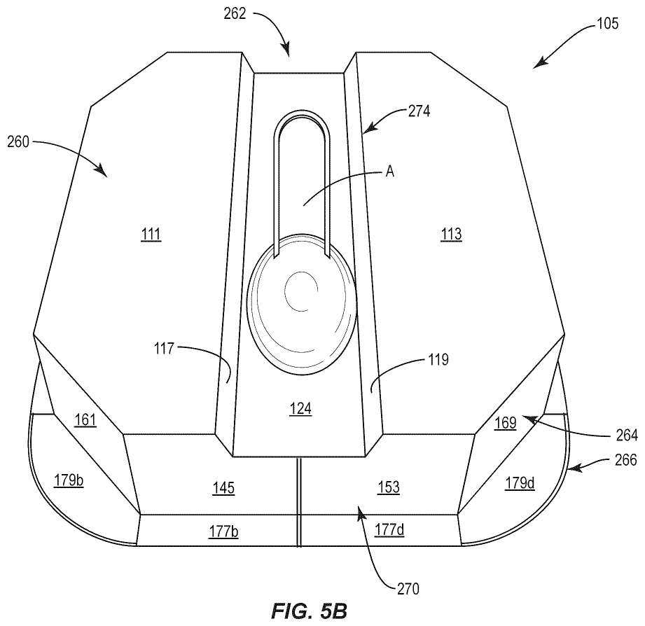

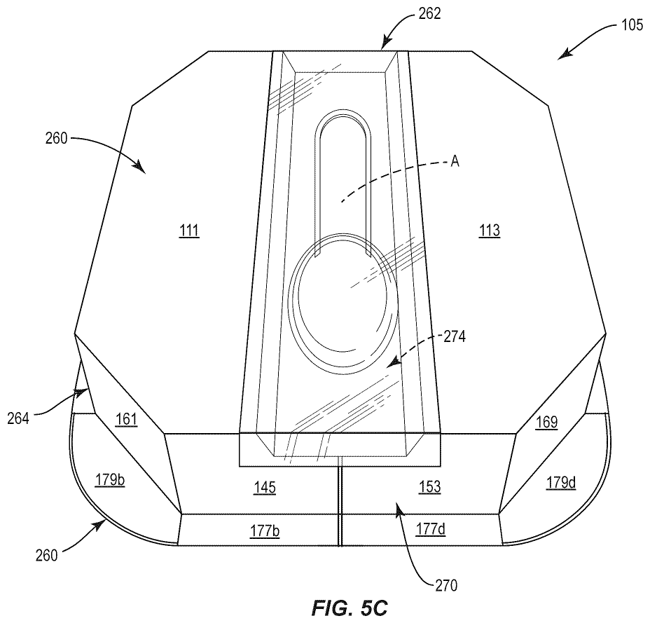

As shown in FIG. 3, the panels 127, 135, 143, 145, 151, 153, 159, 161, 167, 169 can be folded upwardly relative to the bottom panels 111, 113 along their respective fold lines, and the flange portions 175a, 175b, 177a, 177b, 177c, 177d, 179a, 179b, 179c, 179d can be folded outwardly relative to the respective panels 127, 135, 143, 145, 151, 153, 159, 161, 167, 169. As shown in FIGS. 3 and 5B, the bottom edges of the side panels 143, 151, 145, 153 can be positioned along (e.g., to abut and/or to be proximate to) the respective end edges of the storage structure 115 when the panels of the base 270 are folded upwardly relative to the bottom wall 260.

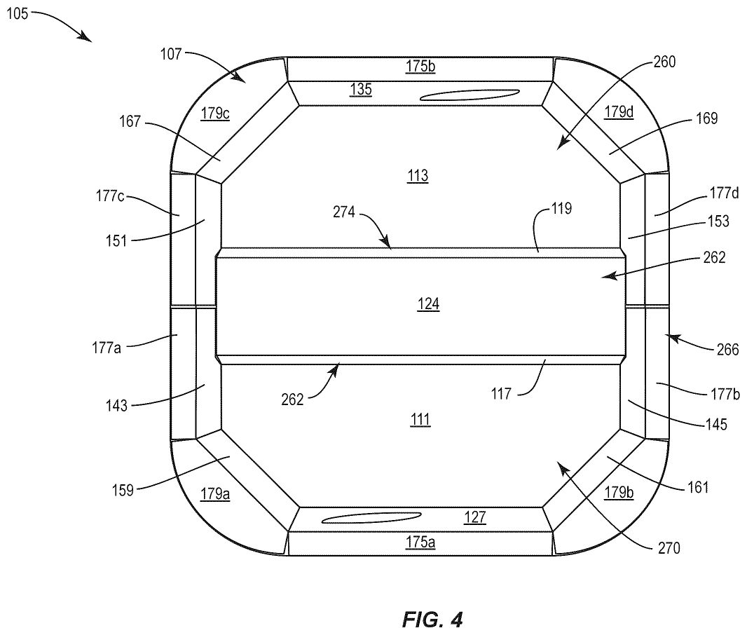

As shown in FIGS. 4-5B, the folded storage structure 115 can form a storage feature or storage compartment 262 (e.g., pocket, trench, groove, etc.) in the bottom wall 260 of the base 270. In embodiments, the panels 127, 135, 143, 145, 151, 153, 159, 161, 167, 169 and the flange portions 175a, 175b, 177a, 177b, 177c, 177d, 179a, 179b, 179c, 179d can be positioned before, after, or during the forming of the bottom wall 260 and the storage feature 262. The storage compartment 262 includes a storage space 274 below the bottom wall 360 and is defined by the storage panels 117, 119, 124. In one embodiment, the positioning of the storage structure 115 includes positioning the first storage panel 117 to extend upwardly from the first bottom panel 111, positioning the second storage panel 119 to extend upwardly from the second bottom panel 113, so that the central storage panel 124 extends between the first storage panel and the second storage panel and is generally parallel to the bottom panels 111, 113 to at least partially define the storage space 274 of the storage compartment 262. The storage compartment 262 can be formed by other folding steps without departing from the disclosure.

The container 105 further can be formed by placing the flange panel 206 of the crown blank 104 over the outwardly-folded flange portions 175a, 175b, 177a, 177b, 177c, 177d, 179a, 179b, 179c, 179d of the base 270 so that the flange portions and the flange panel are in face-to-face contact (e.g., the flange portions are in face-to-face contact with the bottom surface of the flange panel). The flaps 210, 214, 226, 228, 242, 244, 246, 248 can be downwardly folded along their respective fold lines so that the flaps 210, 214, 226, 228, 242, 244, 246, 248 overlap the respective panels 127, 135, 143, 151, 145, 153, 159, 161, 167, 169 (FIG. 3). In embodiments, the flaps 210, 214, 226, 228, 242, 244, 246, 248 and the panels 127, 135, 143, 151, 145, 153, 159, 161, 167, 169 can cooperate to form a sidewall 264 of the container 105. Similarly, the flange portions 175a, 175b, 177a, 177b, 177c, 177d, 179a, 179b, 179c, 179d and the flange panel 206 can cooperate to form a flange 266 of the container 105, with the flange panel 206 providing a smooth, continuous upper surface of the flange 266. Accordingly, in embodiments, the crown 272 at least partially overlaps the base 270 when the base layer 107 of the container 105 is formed.

In embodiments, a liner material (not shown) can be applied over at least the sidewall 264, the bottom wall 260, and the storage feature 262 so that the liner material can form a liner 109 adhered to at least the overlapped flaps and panels of the sidewall 264, to the bottom panels 111, 113 of the bottom wall 260, and to the panels 117, 119, 124 of the storage feature 262 along an interior 268 of the container 105. In embodiments, the liner 109 can be attached along at least a portion of the flange panel 206. In exemplary embodiments, the liner 109 can be adhered to the base layer 107 by a heat seal layer, adhesive, and/or other suitable features. In the illustrated embodiments, the attachment of the liner 109 to the base layer 107 can attach the flaps 210, 214, 226, 228, 242, 244, 246, 248 to the respective panels 127, 135, 143, 151, 145, 153, 159, 161, 167, 169. As shown in FIG. 3, the flaps 210, 214, 226, 228, 242, 244, 246, 248 are smaller than the respective panels 127, 135, 143, 151, 145, 153, 159, 161, 167, 169 so that portions of each of the flaps and panels are in contact with the liner 109. In embodiments, the liner 109 can at least partially hold the crown 272 and the base 270 of the base layer 107 together and maintain the shape of the container 105. Alternatively, or in addition, one or more aspects of the base layer 107 can be attached by thermo-mechanical sealing, adhesive, etc. In exemplary embodiments, the overlapping of the flaps 210, 214, 226, 228, 242, 244, 246, 248 with the respective panels 127, 135, 143, 145, 151, 153, 159, 161, 167, 169 can help increase the rigidity of the sidewall 264 of the container 105.

As shown in FIG. 3, the sidewall 264 and the bottom wall 260 can extend around and at least partially define the interior 268 of the container 105, and the storage feature 262 can extend upwardly into the interior 268. As shown in FIGS. 4-5B, the storage compartment 262 can at least partially define a storage space 274 (e.g., groove, trench, pocket, or other feature) extending upwardly from the exterior/bottom surface of the bottom wall 260 and separated from the interior 268 of the container 105 by at least the storage panels 117, 119, 124. As shown in FIGS. 5A and 5B, an accessory A, such as a spoon, fork, and/or other suitable utensil(s); a dressing/sauce packet; and/or other suitable items. In the illustrated embodiments, the compartment 262 can be covered (e.g., for holding the accessory in the compartment storage space 274) by a covering, film, label, and/or other suitable features. For example, a covering 276 (schematically shown in FIG. 5C) can be secured (e.g., with glue, heat sealing, welding, etc.) at least partially over the open bottom and the open ends of the compartment 262 to at least partially hold the accessory A in the compartment 262. In exemplary embodiments, the covering 276 can form a seal over the compartment to keep the accessory A hygienic in the compartment 262 until the compartment is opened for accessing/using the accessory A. Accordingly, the compartment 262 can provide clean storage that is separate from the food and/or other products held in the interior 268 of the container 105 for an accessory A. The storage compartment 262, including the storage space 274 and/or the covering 276, could be otherwise shaped, arranged, positioned, and/or configured without departing from the disclosure.

All dimensional information presented herein is intended to be illustrative of certain aspects, features, etc., of various embodiments of the disclosure, and is not intended to limit the scope of the disclosure. The dimensions of the blanks, containers, forming tools, features, or any other dimension, can be more or less than what is shown and described in this disclosure without departing from the scope of this disclosure and can be within the listed ranges of dimensions for each feature or outside the listed ranges of dimensions for each feature without departing from the scope of this disclosure.

The blanks according to the present invention can be, for example, formed from coated paperboard and similar materials. For example, the interior and/or exterior sides of the blanks can be coated with a clay coating. The clay coating may then be printed over with product, advertising, price coding, and other information or images. The blanks may then be coated with a varnish to protect any information printed on the blanks. The blanks may also be coated with, for example, a moisture barrier layer, on either or both sides of the blanks.

In general, the blanks may be constructed from paperboard having a caliper so that it is heavier and more rigid than ordinary paper. The blank can also be constructed of other materials, such as cardboard, or any other material having properties suitable for enabling the carton to function at least generally as described above. The blanks can be coated with, for example, a clay coating. The clay coating may then be printed over with product, advertising, and other information or images. The blanks may then be coated with a varnish to protect information printed on the blanks. The blanks may also be coated with, for example, a moisture barrier layer, on either or both sides of the blanks. The blanks can also be laminated to or coated with one or more sheet-like materials at selected panels or panel sections.

In accordance with the exemplary embodiments, a fold line can be any substantially linear, although not necessarily straight, form of weakening that facilitates folding therealong. More specifically, but not for the purpose of narrowing the scope of the present disclosure, fold lines include: a score line, such as lines formed with a blunt scoring knife, or the like, which creates a crushed or depressed portion in the material along the desired line of weakness; a cut that extends partially into a material along the desired line of weakness, and/or a series of cuts that extend partially into and/or completely through the material along the desired line of weakness; and various combinations of these features. In situations where cutting is used to create a fold line, typically the cutting will not be overly extensive in a manner that might cause a reasonable user to incorrectly consider the fold line to be a tear line.

The above embodiments may be described as having one or more panels adhered together by glue during erection of the carton embodiments. The term “glue” is intended to encompass all manner of adhesives commonly used to secure carton panels in place.

The foregoing description illustrates and describes various embodiments of the present disclosure. As various changes could be made in the above construction without departing from the scope of the disclosure, it is intended that all matter contained in the above description or shown in the accompanying drawings shall be interpreted as illustrative and not in a limiting sense. Furthermore, the scope of the present disclosure covers various modifications, combinations, and alterations, etc., of the above-described embodiments. Additionally, the disclosure shows and describes only selected embodiments, but various other combinations, modifications, and environments are contemplated and are within the scope of the inventive concept as expressed herein, commensurate with the above teachings, and/or within the skill or knowledge of the relevant art. Furthermore, certain features and characteristics of each embodiment may be selectively interchanged and applied to other illustrated and non-illustrated embodiments without departing from the scope of the disclosure.

Additionally, spatially relative terms, such as “bottom” or “top”; or “front” or “back”; and the like can be used to describe an element and/or feature's relationship to another element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as a “bottom” surface can then be oriented “above” other elements or features. The device can be otherwise oriented (e.g., rotated 90 degrees or at other orientations) and the spatially relative descriptors used herein interpreted accordingly.

Terms “and,” “or,” and “an/or,” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, B, C, AB, AC, BC, AA, AAB, ABC, AABBCCC, etc.

Reference throughout this specification to “one example,” “an example,” “certain examples,” “exemplary embodiments”, or “exemplary implementation” means that a particular feature, structure, or characteristic described in connection with the feature and/or example may be included in at least one feature and/or example of claimed subject matter. Thus, the appearances of the phrase “in one example,” “an example,” “in certain examples,” “in certain implementations,” “in some embodiments”, or other like phrases in various places throughout this specification are not necessarily all referring to the same feature, example, and/or limitation. Furthermore, the particular features, structures, or characteristics may be combined in one or more examples and/or features.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter. Therefore, it is intended that claimed subject matter not be limited to the particular examples disclosed, but that such claimed subject matter may also include all aspects falling within the scope of appended claims, and equivalents thereof.

What is claimed is:

1. A container for holding one or more products, the container comprising:
a base comprising a bottom panel and a plurality of panels foldably connected to the bottom panel;
a crown comprising a flange panel extending at least partially around an opening and a plurality of flaps foldably connected to the flange panel;
a bottom wall comprising the bottom panel of the base;
a sidewall comprising the plurality of panels of the base and the plurality of flaps of the crown,
the sidewall and the bottom wall at least partially defining an interior of the container;
a flange comprising the flange panel, the flange extends outwardly from the sidewall;
a storage feature at least partially defined in the bottom wall, the storage feature comprising a storage compartment separated from the interior of the container.

2. The container of claim 1, wherein the storage feature comprises a storage structure that forms the storage compartment.

3. The container of claim 2, wherein the storage compartment is accessible from an exterior of the container.

4. The container of claim 2, wherein the storage structure comprises at least one storage panel foldably connected to the bottom panel.

5. The container of claim 4, wherein the bottom panel is a first bottom panel, the base comprises a second bottom panel, and the storage structure is foldably connected to each of the first bottom panel and the second bottom panel.

6. The container of claim 5, wherein the storage structure comprises a first storage panel foldably connected to the first bottom panel, a second storage panel foldably connected to the second bottom panel, and a central storage panel foldably connected to the first storage panel and the second storage panel.

7. The container of claim 6, wherein the first storage panel extends upwardly from the first bottom panel, the second storage panel extends upwardly from the second bottom panel, and the central storage panel extends between the first storage panel and the second storage panel to at least partially define a storage space of the storage compartment.

8. The container of claim 7, wherein the central storage panel is generally parallel to the first bottom panel and the second bottom panel, the central storage panel being spaced apart from the first bottom panel and the second bottom panel by the first storage panel and the second storage panel.

9. The container of claim 6, wherein the plurality of panels comprises a first side panel foldably connected to the first bottom panel and second side panel foldably connected to the second bottom panel, the first side panel and the second side panel are shaped to form a portion of the sidewall extending upwardly from the storage structure.

10. The container of claim 6, wherein the plurality of panels comprises a respective flange portion for cooperating with the flange panel of the crown to form the flange.

11. The container of claim 1, wherein the plurality of flaps of the crown comprises a plurality of side flaps, a plurality of end flaps, and a plurality of corner flaps, the plurality of panels of the base comprises a plurality of side panels, a plurality of end panels, and a plurality of corner panels, the plurality of side panels, the plurality of end panels, and the plurality of corner panels cooperate with a respective one of the plurality of side flaps, the plurality of end flaps, and the plurality of corner flaps to form the sidewall.

12. A combination of blanks for forming a container for holding one or more products, the combination of blanks comprises:
a base blank for forming a base of the container, the base blank comprising a bottom panel and a plurality of panels foldably connected to the bottom panel, the bottom panel for forming a bottom wall of the base of the container;
a crown blank comprising a flange panel extending at least partially around an opening and a plurality of flaps foldably connected to the flange panel, the flange panel for at least partially forming a flange of the container,
the plurality of flaps of the crown blank and the plurality of panels of the base blank for forming a sidewall extending at least partially around an interior of the container formed from the combination of blanks, the sidewall and the bottom wall at least partially defining the interior of the container formed from the combination of blanks,
the flange of the container extends outwardly from the sidewall,
a storage structure for forming a storage feature in the container formed from the combination of blanks, the storage structure at least partially defined in the bottom panel, the storage feature comprising a storage compartment separated from the interior of the container formed from the combination of blanks.

13. The combination of blanks of claim 12, wherein the storage structure comprises at least one storage panel foldably connected to the bottom panel.

14. The combination of blanks of claim 13, wherein the bottom panel is a first bottom panel, the base blank comprises a second bottom panel, and the storage structure is foldably connected to each of the first bottom panel and the second bottom panel.

15. The combination of blanks of claim 14, wherein the storage structure comprises a first storage panel foldably connected to the first bottom panel, a second storage panel foldably connected to the second bottom panel, and a central storage panel foldably connected to the first storage panel and the second storage panel.

16. The combination of blanks of claim 15, wherein the first storage panel is for extending upwardly from the first bottom panel, the second storage panel is for extending upwardly from the second bottom panel, and the central storage panel extends between the first storage panel and the second storage panel to at least partially define a storage space of the storage compartment in the container formed from the combination of blanks.

17. The combination of blanks of claim 16, wherein the central storage panel is for being generally parallel to the first bottom panel and the second bottom panel, the central storage panel is for being spaced apart from the first bottom panel and the second bottom panel by the first storage panel and the second storage panel in the container formed from the combination of blanks.

18. The combination of blanks of claim 15, wherein the plurality of panels comprises a first side panel foldably connected to the first bottom panel and second side panel foldably connected to the second bottom panel, the first side panel and the second side panel are shaped to form a portion of the sidewall extending upwardly from the storage structure in the container formed from the combination of blanks.

19. The combination of blanks of claim 18, wherein the plurality of panels comprises a respective flange portion for cooperating with the flange panel of the crown blank to form the flange in the container formed from the blank.

20. The combination of blanks of claim 12, wherein the plurality of flaps of the crown blank comprises a plurality of side flaps, a plurality of end flaps, and a plurality of corner flaps, the plurality of panels of the base blank comprises a plurality of side panels, a plurality of end panels, and a plurality of corner panels, the plurality of side panels, the plurality of end panels, and the plurality of corner panels cooperate with a respective one of the plurality of side flaps, the plurality of end flaps, and the plurality of corner flaps to form the sidewall in the container formed by the combination of blanks.

21. A method of forming a container for holding one or more products, the method comprising:
obtaining a base blank, the base blank comprising a bottom panel, a plurality of panels foldably connected to the bottom panel, and a storage structure at least partially defined in the bottom panel;
obtaining a crown blank comprising a flange panel extending at least partially around an opening and a plurality of flaps foldably connected to the flange panel;
forming a base from the base blank;
forming a crown from the crown blank;
at least partially forming a flange from the flange panel;
forming a bottom wall of the container from the bottom panel and forming a sidewall of the container from the plurality of panels of the base blank and the plurality of flaps of the crown blank such that the sidewall extends at least partially around an interior of the container, the sidewall and the bottom wall at least partially defining the interior of the container, the flange of the container extends outwardly from the sidewall,
forming a storage feature from the storage structure, the storage feature comprising a storage compartment separated from the interior of the container.

22. The method of claim 21, wherein the storage feature comprises a storage structure that forms the storage compartment.

23. The method of claim 22, wherein the storage compartment is accessible from an exterior of the container.

24. The method of claim 21, wherein the storage structure comprises at least one storage panel foldably connected to the bottom panel.

25. The method of claim 24, wherein the bottom panel is a first bottom panel, the base blank comprises a second bottom panel, and the storage structure is foldably connected to each of the first bottom panel and the second bottom panel.

26. The method of claim 25, wherein the storage structure comprises a first storage panel foldably connected to the first bottom panel, a second storage panel foldably connected to the second bottom panel, and a central storage panel foldably connected to the first storage panel and the second storage panel.

27. The method of claim 26, wherein the forming the storage feature comprises positioning the first storage panel to extend upwardly from the first bottom panel, positioning the second storage panel to extend upwardly from the second bottom panel, and positioning the central storage panel to extend between the first storage panel and the second storage panel to at least partially define a storage space of the storage compartment.

28. The method of claim 27, wherein the central storage panel is generally parallel to the first bottom panel and the second bottom panel, the central storage panel being spaced apart from the first bottom panel and the second bottom panel by the first storage panel and the second storage panel.

29. The method of claim 26, wherein the plurality of panels comprises a first side panel foldably connected to the first bottom panel and second side panel foldably connected to the second bottom panel, the first side panel and the second side panel are shaped to form a portion of the sidewall extending upwardly from the storage structure.

30. The method of claim 26, wherein the plurality of panels comprises a respective flange portion for cooperating with the flange panel of the crown blank to form the flange.

31. The method of claim 21, wherein the plurality of flaps of the crown blank comprises a plurality of side flaps, a plurality of end flaps, and a plurality of corner flaps, the plurality of panels of the base blank comprises a plurality of side panels, a plurality of end panels, and a plurality of corner panels, the plurality of side panels, the plurality of end panels, and the plurality of corner panels cooperate with a respective one of the plurality of side flaps, the plurality of end flaps, and the plurality of corner flaps to form the sidewall.
